(19) United States
(12) Patent Application Publication
(10) Pub. No.: US 2020/0298519 A1
(43) Pub. Date: Sep. 24, 2020

(54) TIRE VULCANIZING MOLD, METHOD FOR MANUFACTURING TIRE VULCANIZING MOLD, AND METHOD FOR MANUFACTURING TIRE

(71) Applicant: Toyo Tire Corporation, Itami-shi (JP)

(72) Inventor: Masaaki Sakura, Itami-shi (JP)

(73) Assignee: Toyo Tire Corporation, Itami-shi (JP)

(21) Appl. No.: 16/808,917

(22) Filed: Mar. 4, 2020

(30) Foreign Application Priority Data
Mar. 19, 2019 (JP) 2019-051597

(51) Int. Cl. B29D 30/72; B29D 30/06

(52) U.S. Cl. CPC B29D 30/72; B60C 13/001; B29D 2030/726; B29D 30/0662

(57) ABSTRACT

A tire vulcanizing mold includes: a tire molding surface to be brought into contact with an outer surface of a tire set in a cavity; a mounting groove provided on the tire molding surface; a stencil plate to be mounted on the mounting groove and having a recess for forming a protruding identification mark on the outer surface; and a bottom-raised portion configured to support the stencil plate at a position not interfering with the recess in the mounting groove.

### BACKGROUND OF THE INVENTION

### Field of the Invention

The present disclosure relates to a tire vulcanizing mold in which a stencil plate is mounted onto a tire molding surface, a method for manufacturing the tire vulcanizing mold, and a method for manufacturing a tire, which vulcanizes and molds a tire by using these.

### Description of the Related Art

On an outer surface of a pneumatic tire, there is formed an identification mark including characters and symbols, which indicate a tire size, a load index, a manufacturer name, a year and week of manufacture, and the like. As described in Patent Document 1 and 2, a stencil plate (also referred to as a “serial plate”) formed of a metal thin plate is sometimes used in order to form the identification mark. On the stencil plate, protrusions and recesses, which correspond to the identification mark, are formed by embossing and the like. An unvulcanized tire is thrust against the stencil plate attached onto a mounting groove of a tire molding surface in a tire vulcanizing mold, and the identification mark is formed by transcription on a surface of such a tire already vulcanized and molded.

Heretofore, a portion of the identification mark has been formed of protrusions of the stencil plate, and a flat portion other the identification mark is formed so as to contact a bottom surface of the mounting groove of the stencil plate. By the stencil plate having the protrusions, the identification mark that is recessed is formed on the outer surface of the tire.

Incidentally, in recent years, a tire in which the identification mark protrudes has been required since visibility of the identification mark has been required to be improved.

### PRIOR ART DOCUMENTS

### Patent Documents

Patent Document 1: JP-A-2005-088517

Patent Document 2: JP-A-2014-172360

### SUMMARY OF THE INVENTION

In order to form the protruding identification mark on the outer surface of the tire, it is necessary to reverse the protrusions and recesses of the stencil plate from the conventional ones. Specifically, as illustrated in FIG. 8, it is necessary to form such an identification mark of recesses 34 of a stencil plate 3, and to form a flat portion 36 other than the identification mark so that the flat portion 36 can be isolated from a bottom surface 21 of a mounting groove for the stencil plate 3.

However, it is found that the following problem occurs in the tire vulcanizing mold illustrated in FIG. 8. On a central portion of the stencil plate 3, there are a large number of the recesses 34 on an identification mark portion in contact with the bottom surface 21 of the mounting groove. Meanwhile, an outer edge portion of the stencil plate 3 is formed of only a flat portion 36 other than the identification mark, the flat portion 36 being isolated from the bottom surface 21 of the mounting groove. Therefore, in some cases, the stencil plate 3 is mounted in an inclined state, or the stencil plate 3 is bent by a pressing force of rubber. Then, when the stencil plate 3 is inclined or bent, a gap 9 between the outer edge portion of the stencil plate 3 and a tire molding surface 1 is increased. When the rubber flows into the gap 9, a burr is generated on the tire already vulcanized and molded. When a level difference caused by the gap 9 is transferred to the tire, a pinch is generated on the tire already vulcanized and molded. The burr is one in which an extra coating is formed to protrude on the surface of the tire, and causes a decrease of the visibility of the identification mark. The pinch is an unintended level difference generated on the surface of the tire, and causes a failure of an exterior appearance of the tire.

The present disclosure has been made in view of the actual circumstances described above, and it is an object of the present disclosure to provide a tire vulcanizing mold capable of suppressing the inclination and bend of the mounted stencil plate, a method for manufacturing the tire vulcanizing mold, and a method for manufacturing a tire by using the tire vulcanizing mold.

The above object can be achieved by the present disclosure as described below. Specifically, a tire vulcanizing mold according to the present disclosure includes:

a tire molding surface to be brought into contact with an outer surface of a tire set in a cavity;

a mounting groove provided on the tire molding surface;

a stencil plate to be mounted on the mounting groove and having a recess for forming a protruding identification mark on the outer surface; and

a bottom-raised portion configured to support the stencil plate at a position not interfering with the recess in the mounting groove.

In accordance with this configuration, the bottom-raised portion supports the stencil plate so as not to interfere with the recess of the stencil plate, and accordingly, the inclination of the stencil plate is suppressed. Moreover, the stencil plate is difficult to bend due to the pressing force of rubber. Hence, the gap through which rubber flows in between the outer edge portion of the stencil plate and the tire molding surface is reduced, and the burr can be suppressed from being generated. Moreover, the level difference between the tire molding surface and the stencil plate is reduced, and the pinch can be suppressed from being generated.

The bottom-raised portion may include a spacer member attached onto the mounting groove, or may be formed integrally with the tire molding surface.

The bottom-raised portion may be formed along an inner wall of the mounting groove.

The bottom-raised portion may include a portion formed so as to connect a pair of inner walls to each other, the inner walls facing each other in a width direction of the mounting groove.

The above object can be achieved by the present disclosure as described below. That is, a method for manufacturing a tire vulcanizing mold according to the present disclosure includes:

an attaching step of attaching a spacer member into a mounting groove provided in a tire vulcanizing mold, the spacer member serving for raising a bottom surface height of a part of the mounting groove; and

a mounting step of mounting a stencil plate on the mounting groove attached with the spacer member, the stencil plate having a recess for forming a protruding identification mark on an outer surface of a tire,

wherein, in the attaching step, the spacer member is attached to a position not interfering with the recess of the stencil plate.

Furthermore, a method for manufacturing a tire vulcanizing mold according to the present disclosure includes:

a cutting-out step of cutting out a mounting groove on a tire molding surface of a tire vulcanizing mold; and

a mounting step of mounting a stencil plate on the mounting groove, the stencil plate having a recess for forming a protruding identification mark on an outer surface of a tire,

wherein, in the cutting-out step, the mounting groove is cut out so as to form a bottom-raised portion at a position not interfering with the recess of the stencil plate, the bottom-raised portion being obtained by raising a bottom surface height of a part of the mounting groove.

A method for manufacturing a tire according to the present disclosure includes:

a step of vulcanizing and molding a tire by using the above-described tire vulcanizing mold or by using a tire vulcanizing mold manufactured by the above-described method for manufacturing a tire vulcanizing mold.

### BRIEF DESCRIPTION OF THE DRAWINGS

FIG. 1 is a cross-sectional view of a tire vulcanizing mold, taken along a tire meridian cross section;

FIG. 2 is a plan view viewed from arrow X in FIG. 1;

FIG. 3 is a cross-sectional view illustrating a first embodiment of a mounting groove;

FIG. 4 is a plan view illustrating the first embodiment of the mounting groove;

FIG. 5 is a cross-sectional view illustrating a second embodiment of the mounting groove;

FIG. 6 is a plan view illustrating a third embodiment of the mounting groove;

FIG. 7(a) is a plan view illustrating a fourth embodiment of the mounting groove; and FIG. 7(b) is a cross-sectional view taken along line Y-Y in FIG. 7(a); and

FIG. 8 is a view illustrating a problem of a conventional tire vulcanizing mold on which a stencil plate is mounted.

### DETAILED DESCRIPTION OF THE PREFERRED EMBODIMENTS

### First Embodiment

Hereinafter, an embodiment according to the present disclosure will be described with reference to the drawings. Note that, in the respective drawings, dimensional ratios in the drawings and actual dimensional ratios do not necessarily coincide with each other, and moreover, dimensional ratios between the respective drawings do not necessarily coincide with one another.

FIG. 1 illustrates a cross section of a tire vulcanizing mold 10 (hereinafter, sometimes simply referred to as a “mold 10”), taken along a tire meridian cross section. This mold 10 is in a closed state. A tire T is set so that a tire width direction is aligned with a vertical direction. In FIG. 1, a left direction is an outside in a tire radial direction, and a right direction is an inside in the tire radial direction.

The mold 10 includes: a tread mold portion 11 configured to mold a tread portion of the tire T; a pair of side mold portions 12 and 13 configured to mold sidewall portions of the tire T; and a pair of bead rings 14 and 15 to which bead portions of the tire T are to be fitted. The mold 10 includes a tire molding surface 1 to be brought into contact with an outer surface of the tire T set in a cavity 16. The tire molding surface 1 includes an inner surface of the tread mold portion 11, inner surfaces of the side mold portions 12 and 13, and inner surfaces of the bead rings 14 and 15. Although not shown, on the inner surface of the tread mold portion 11, there is formed an irregular portion for forming a tread pattern on a tread surface of the tire T.

An aluminum member is illustrated as a material of the inner surface of the tread mold portion 11. This aluminum member is a concept including not only a pure aluminum-based material but also an aluminum alloy, and examples of the aluminum member include Al—Cu-based, Al—Mg-based, Al—Mg—Si-based, Al—Zn—Mg-based, Al—Mn-based, and Al—Si-based materials. As a material of the inner surfaces of the side mold portions 12 and 13 and the bead rings 14 and 15, a steel material such as a rolled steel for general structure (for example, SS400 (JIS Standard)) is illustrated.

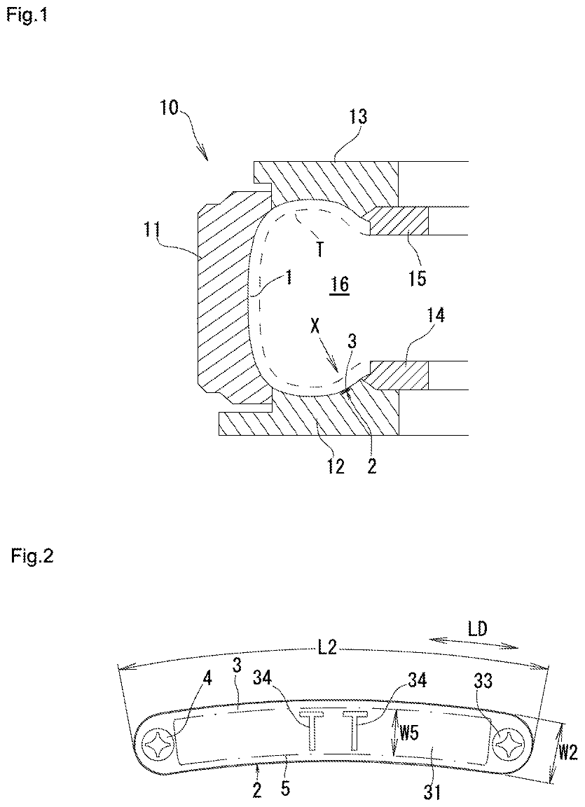

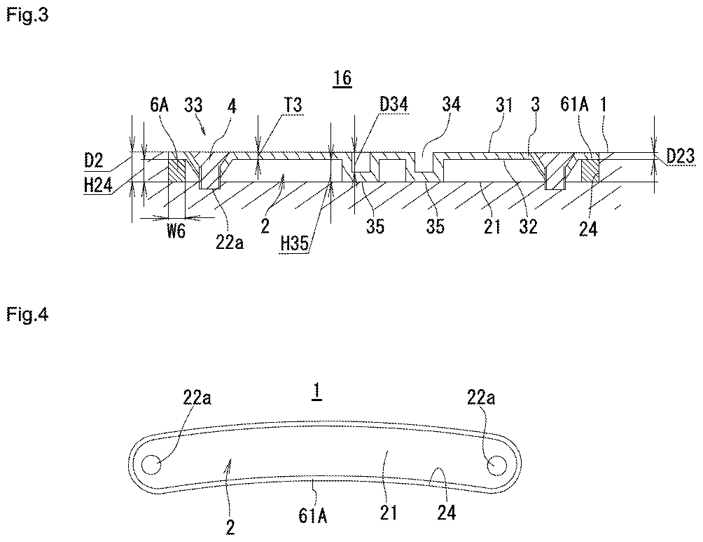

The mold 10 includes: the tire molding surface 1 to be brought into contact with the outer surface of the tire T set in the cavity 16; a mounting groove 2 provided on the tire molding surface 1; and a stencil plate 3 to be mounted on the mounting groove 2 and having recesses 34 (see FIGS. 2 and 3) for forming a protruding identification mark on the outer surface of the tire T. The mounting groove 2 is provided by denting a part of the tire molding surface 1. In this embodiment, the mounting groove 2 is provided on the inner surface of the side mold portion 12, which is the tire molding surface 1.

FIG. 2 is a plan view viewed from arrow X in FIG. 1, illustrating the stencil plate 3 fitted onto the mounting groove 2 on an inner surface of the side mold portion 12 located on a lower side of FIG. 1. In FIG. 2, a crosswise direction corresponds to a tire circumferential direction, an upper direction is an outside in the tire radial direction, and a lower direction is an inside of the tire radial direction.

The mounting groove 2 and the stencil plate 3 have an oblong shape in which a length in the tire circumferential direction is larger than a width in the tire radial direction. For example, such a width W2 is 11.3 mm. Dimensions of the stencil plate 3, such as the length in the tire circumferential direction and the width of the tire radial direction, are a little smaller than dimensions of the mounting groove 2, and rubber does not intrude into a gap between the mounting groove 2 and the stencil plate 3.

The dimensions of the mounting groove 2 and the stencil plate 3 can be set according to a length of characters and symbols of the identification mark. In this embodiment, the mounting groove 2 and the stencil plate 3 are curved into a circular arc shape along the tire circumferential direction; however, without being limited to this, may have a shape extending linearly in a longitudinal direction LD.

The stencil plate 3 is provided with recesses 34 for forming a protruding identification mark on the outer surface of the tire T. This embodiment illustrates an example in which the identification mark is formed of a character string that is “TT”. The identification mark is not limited to characters, and may be symbols and the like. Hence, the following description mentions “characters” as the identification mark; however, without being limited to this, the identification mark may include “symbols” as a matter of course.

A character forming region on the stencil plate 3, that is, a recess forming region 5 (a frame inside shown by a dashed line in FIG. 2) is smaller than such a dimensional size of the stencil plate 3. Then, the recess forming region 5 is provided in a portion excluding an outer edge portion of the stencil plate 3 and peripheral portions of screws 4 located on both end portions of the stencil plate 3. For example, a width W5 of the recess forming region 5 is preferably 7.6 mm or more, and preferably 8.0 mm or less. When the width W5 remains within this numerical value range, an identification mark having a size (a longitudinal length) of characters, which is approximately 7 mm, can be formed.

FIG. 3 illustrates a cross section showing the first embodiment of the mounting groove 2 on which the stencil plate 3 is mounted. Through holes 33 for attaching the screws 4 are provided on both end portions of the stencil plate 3 in the longitudinal direction LD. The screws 4 are screwed to female screws of holes 22a located on the bottom surface 21 of the mounting groove 2 through the through holes 33, and the stencil plate 3 is fixed to the mounting groove 2.

The stencil plate 3 is detachably attached to the tire molding surface 1 through interposition of the screws 4. When the identification mark is changed, for example, when a year and week of manufacture are updated, the stencil plate 3 is detached from the tire molding surface 1, and another stencil plate on which recesses for forming a different identification mark are provided is mounted thereon. Top surfaces of the screws 4 are disposed so as to be flush with the tire molding surface 1; however, without being limited to this, may be brought close to the bottom surface 21 of the mounting groove 2 for example.

The stencil plate 3 is preferably formed of a plate material made of metal such as stainless steel and aluminum. From a viewpoint of easiness of processing, and so on, it is preferable that a thickness T3 of the stencil plate 3 be 0.6 mm or less for example. From a viewpoint of giving an appropriate strength to the stencil plate 3, it is preferable that the thickness T3 be 0.3 mm or more.

The stencil plate 3 has a front surface 31 facing a cavity 16, and a back surface 32 facing the bottom surface 21 of the mounting groove 2. At the time of vulcanization and molding, the outer surface of the tire T is thrust against the front surface 31 of the stencil plate 3, and the identification mark is formed into a protruding shape on the outer surface of the tire T by transcription. It is preferable that the front surface 31 be disposed so as to be flush with the tire molding surface 1. The front surface 31 may have a level difference from the tire molding surface 1 as long as a pinch of the tire T on which the identification mark is transferred is in a negligible degree.

The front surface 31 is provided with recesses 34 for forming a protruding identification mark on the outer surface of the tire T. For example, the recesses 34 are formed to be dented by embossing from the front surface 31. The back surface 32 is provided with protrusions 35 corresponding to the recesses 34. The protrusions 35 are formed so as to correspond to the recesses 34 which are formed to be dented. Hence, the protrusions 35 are the recesses 34 when viewed from the back surface 32 of the stencil plate 3. A protrusion height H35 of the protrusions 35 is substantially the same value as a depth D34. The protrusion height H35 is obtained while taking the back surface 32, which is not the protrusions 35, as a reference. The protrusions 35 are preferably formed so as to contact the bottom surface 21 of the mounting groove 2. Then, the protrusion height H35 is preferably a value obtained by subtracting the thickness T3 of the stencil plate 3 from a groove depth D2 of the mounting groove 2. For example, the depth D34 of the recesses 34 is preferably set to 0.6 mm. For example, the groove depth D2 of the mounting groove 2 is preferably set to 1.2 mm.

The mold further includes a bottom-raised portion 6A configured to support the stencil plate 3. An upper surface 61A of the bottom-raised portion 6A is higher than the bottom surface 21 of the mounting groove 2. That is, the upper surface 61A is located more inside (closer to the cavity 16) in the tire width direction than the bottom surface 21 of the mounting groove 2. Moreover, the upper surface 61A is lower than the tire molding surface 1. That is, the upper surface 61A is located more outside in the tire width direction than the tire molding surface 1. A height H24 from the bottom surface 21 to the upper surface 61A is smaller than the groove depth D2 of the mounting groove. For example, the height H24 is preferably 0.6 mm or more, and preferably 0.9 mm or less. For example, a width W6 of the bottom-raised portion 6A is preferably 1.4 mm or more, and preferably 1.8 mm or less. The bottom-raised portion 6A is provided on the mounting groove 2, whereby the back surface 32 of the stencil plate 3 is supported by the upper surface 61A of the bottom-raised portion 6A. Then, when the stencil plate 3 is disposed on the mounting groove 2, the stencil plate 3 is suppressed from being inclined or bent, and a gap between the outer edge portion of the stencil plate 3 and the tire molding surface 1 does not increase.

The bottom-raised portion 6A is provided at a position not interfering with the recesses 34 of the stencil plate 3. In other words, the bottom-raised portion 6A is provided outside of the recess forming region 5. The height H24 of the bottom-raised portion 6A is preferably the same value as the protrusion height H35. Thus, the stencil plate 3 can be supported by both of the identification mark portion and the bottom-raised portion 6A. However, in consideration of a manufacturing error of the protrusion height H35 of the stencil plate 3, the height H24 of the bottom-raised portion 6A may be made a little larger than the protrusion height H35 of the stencil plate 3. Moreover, it is preferable that a depth D23 from the tire molding surface 1 to the upper surface 61A of the bottom-raised portion 6A be the same value as the thickness T3 of the stencil plate 3.

In this embodiment, the bottom-raised portion 6A is preferably formed by an attaching step of attaching a spacer member to the mounting groove 2. A method for forming the bottom-raised portion 6A by attaching the spacer member has an advantage that a mounting groove of a stencil plate of a conventional mold can be utilized. In other words, it is not necessary to fabricate a new metal mold, or to reprocess the mounting groove on a large-scale basis. The spacer member is not particularly limited as long as the spacer member is made of a material that can raise a part of the bottom surface 21 of the mounting groove 2 to form the upper surface 61A; however, is preferably made of metal such as stainless steel. Regarding a method for attaching the spacer member to the mounting groove 2, it is preferable that the spacer member be fixed to the mounting groove 2 by welding. An adhesive may be used for the fixation. Moreover, in order to make the spacer member detachable, a tacking agent or a tacking tape may be used for the fixation. By making the spacer member detachable, it becomes possible to switch to a stencil plate for forming a recessed identification mark on the outer surface of the tire T, the stencil plate requiring no bottom-raised portion.

After the bottom-raised portion 6A formed of the spacer member is disposed on the mounting groove 2, a mounting step of mounting the stencil plate 3 on the mounting groove 2 is performed. In the attaching step, the spacer member is attached to a position not interfering with the recesses 34 of the stencil plate 3. As a modified example, the spacer member may be pasted onto a predetermined position (a position including an outer edge of the back surface of the stencil plate 3) of the back surface of the stencil plate 3, and the stencil plate attached with the spacer member may be fitted into the mounting groove 2.

FIG. 4 is a plan view of the mounting groove 2 to which the stencil plate and the screws are not attached. In this embodiment, the bottom-raised portion 6A is formed annularly along an inner wall 24 of the mounting groove 2. Thus, the upper surface 61A of the annular bottom-raised portion 6A can support all the outer edge portion of the stencil plate 3 from the back surface. Hence, the gap with the tire molding surface 1 is not increased over all the outer edge portion of the stencil plate 3.

### Second Embodiment

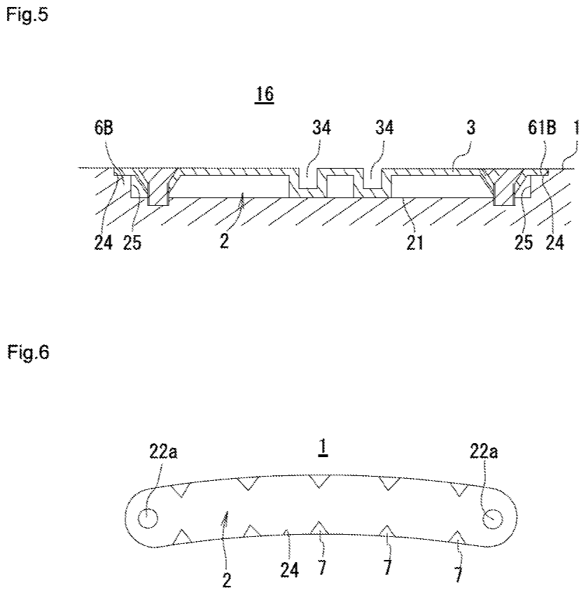

A second embodiment is described with reference to FIG. 5. Matters other than those described below can be carried out like the first embodiment. The same also applies to a third embodiment and a fourth embodiment.

FIG. 5 illustrates a mounting groove 2 on which a stencil plate 3 is mounted. A bottom-raised portion 6B in the second embodiment is not such a spacer member formed separately from a tire molding surface 1, but is formed as a part of the mold. That is, the bottom-raised portion 6B is formed integrally with the tire molding surface 1. Specifically, for example, in a cutting-out step of cutting out the mounting groove 2 from the tire molding surface 1 of the mold, preferably, the mounting groove 2 is cut out so as to form the bottom-raised portion 6B, which is obtained by raising a bottom surface height of a part of the mounting groove 2, at a position not interfering with recesses 34 of the stencil plate 3. In accordance with this, it is not necessary to dispose the spacer member, and accordingly, an advantage is brought, for example, at the time of fabricating a new mold. Dimensions and shape of an upper surface 61B of the bottom-raised portion 6B, the dimensions including a height and a width, are similar to those of the upper surface 61A of the bottom-raised portion 6A formed of the spacer member in the first embodiment. In the second embodiment, the mounting groove 2 has inner walls 24 and 25. The inner wall 24 is formed between the tire molding surface 1 and the upper surface 61B of the bottom-raised portion 6B. The bottom-raised portion 6B is formed along the inner wall 24 of the mounting groove 2. The inner wall 25 is a side surface of the bottom-raised portion 6B, and is formed between the upper surface 61B of the bottom-raised portion 6B and a bottom surface 21 of the mounting groove 2.

### Third Embodiment

A third embodiment is described with reference to FIG. 6. FIG. 6 is a plan view of a mounting groove 2 to which a stencil plate and screws are not attached. Bottom-raised portions in this embodiment are not formed annularly and continuously, and a plurality of the bottom-raised portions 7 are arranged along an inner wall 24 of the mounting groove 2. The respective bottom-raised portions 7 in this embodiment have a triangular shape when the mounting groove 2 is viewed from the above. However, the shape of the respective bottom-raised portions 7 is not limited.

Also in this embodiment, the character forming region (recess forming region) is set; however, also in the inside of the character forming region, there are spots in which characters (recesses) are not actually arranged. One of such spots is a spot that goes along the inner wall 24 of the mounting groove 2, has a wider width than in the first embodiment, and is located between a character and a character. This spot is used for each of the bottom-raised portions 7. Thus, without limiting the character forming region, an area of upper surfaces of the respective bottom-raised portions 7, which is required to support the stencil plate 3, can be ensured.

It is preferable that the respective bottom-raised portions 7 be located at positions not interfering with recesses 34 corresponding to characters of the stencil plate 3 to be mounted later whatever characters the stencil plate 3 to be mounted later may have. That is, it is preferable that the respective bottom-raised portions 7 should not interfere with the recesses 34 even if the stencil plate 3 is switched to a stencil plate having another identification mark. For this purpose, preferably, a design is made so that positions of characters to be arranged on different stencil plates are not changed between the stencil plates.

The bottom-raised portion 7 may be formed of such a spacer member, or may be formed integrally with the tire molding surface 1. Moreover, as a modified example of this embodiment, the bottom-raised portion may include both of the portion formed annularly along the inner wall 24 of the mounting groove 2 and the respective bottom-raised portions 7 according to this embodiment.

### Fourth Embodiment

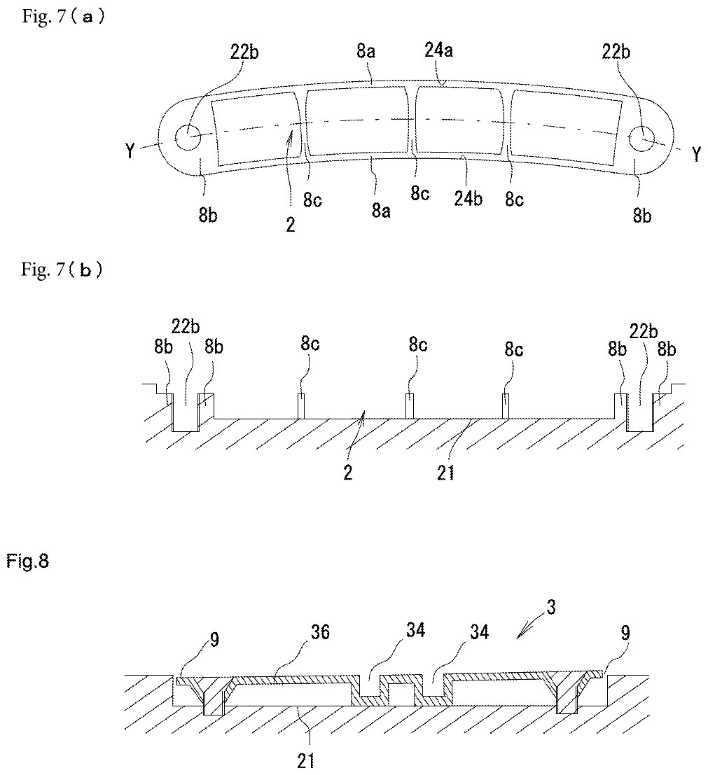

A fourth embodiment is described with reference to FIG. 7. FIG. 7(a) is a plan view of a mounting groove 2 to which a stencil plate and screws are not attached. FIG. 7(b) is a cross-sectional view taken along line Y-Y extending in a longitudinal direction of the mounting groove 2 in FIG. 7(a). A bottom-raised portion in this embodiment includes: wall-side bottom-raised portions 8a formed along inner walls of the mounting groove 2; screw-region bottom-raised portions 8b on both ends of the mounting groove in the longitudinal direction; and inter-character bottom-raised portions 8c each formed in a gap between a character and a character. The wall-side bottom-raised portions 8a and the screw-region bottom-raised portions 8b are disposed outside a character forming region (a recess forming region) of the stencil plate. The bottom-raised portions 8c between the characters are disposed at spots inside the character forming region, in which characters (recesses) are not actually arranged.

In this embodiment, holes 22b are provided in the screw-region bottom-raised portions 8b. Screws 4 can also be supported in insides of the screw-region bottom-raised portions 8b located higher than a bottom surface 21 of the mounting groove 2, and accordingly, the stencil plate can be stably fixed. The bottom-raised portions 8a, 8b, and 8c may be formed of such a spacer member, or may be formed integrally with the tire molding surface 1. Moreover, both of the spacer member and such integral formation with the tire molding surface 1 may be included. When the screws 22b are provided in the screw-region bottom-raised portions 8b, it is preferable that at least the screw-region bottom-raised portions 8b be formed integrally with the tire molding surface 1.

The inter-character bottom-raised portions 8c are formed so as to connect a pair of the wall-side bottom-raised portions 8a, which face each other in a width direction of the mounting groove 2, to each other. Since an area of an upper surface of a whole of the bottom-raised portions is wider than those in the other embodiments, and the bottom-raised portions are arranged on the mounting groove 2 so as to be dispersed thereon, it is easy to appropriately mount the stencil plate without inclining the mounting groove. Moreover, the bend of the stencil plate is more difficult to occur as compared to the other embodiments.

A method for manufacturing a tire according to the present disclosure includes: a step of vulcanizing and molding a tire by using the tire vulcanizing mold according to each of the embodiments described above. Moreover, the respective embodiments can be combined with one another as appropriate, modified examples thereof can be adopted as appropriate, and components thereof can be partially adopted and deleted.

The present disclosure is not limited to the embodiments, and is improvable and modifiable in various ways within the scope without departing from the spirit of the present disclosure. Then, the tire vulcanizing mold mentioned above is equivalent to a usual tire vulcanizing mold except that the tire vulcanizing mold is constructed as mentioned above, and all of a shape, a material, a mechanism and the like, which are well-known heretofore, can be adopted for the present disclosure.

What is claimed is:

1. A tire vulcanizing mold comprising:
a tire molding surface to be brought into contact with an outer surface of a tire set in a cavity;
a mounting groove provided on the tire molding surface;
a stencil plate to be mounted on the mounting groove and having a recess for forming a protruding identification mark on the outer surface; and
a bottom-raised portion configured to support the stencil plate at a position not interfering with the recess in the mounting groove.

2. The tire vulcanizing mold according to claim 1, wherein the bottom-raised portion includes a spacer member attached onto the mounting groove.

3. The tire vulcanizing mold according to claim 1, wherein the bottom-raised portion is formed integrally with the tire molding surface.

4. The tire vulcanizing mold according to claim 1, wherein the bottom-raised portion includes bottom-raised portions formed in screw regions on both ends of the mounting groove in a longitudinal direction.

5. The tire vulcanizing mold according to claim 1, wherein the bottom-raised portion includes a bottom-raised portion formed along an inner wall of the mounting groove.

6. The tire vulcanizing mold according to claim 1, wherein the bottom-raised portion includes a bottom-raised portion formed annularly.

7. The tire vulcanizing mold according to claim 1, wherein the bottom-raised portion includes a triangular bottom-raised portion.

8. The tire vulcanizing mold according to claim 1, wherein the bottom-raised portion includes a bottom-raised portion formed so as to connect a pair of inner walls to each other, the inner walls facing each other in a width direction of the mounting groove.

9. The tire vulcanizing mold according to claim 1, wherein the bottom-raised portion includes a bottom-raised portion formed in a gap between a character and a character.

10. A method for manufacturing a tire vulcanizing mold, the method comprising:
an attaching step of attaching a spacer member into a mounting groove provided in a tire vulcanizing mold, the spacer member serving for raising a bottom surface height of a part of the mounting groove; and
a mounting step of mounting a stencil plate on the mounting groove attached with the spacer member, the stencil plate having a recess for forming a protruding identification mark on an outer surface of a tire,
wherein, in the attaching step, the spacer member is attached to a position not interfering with the recess of the stencil plate.

11. A method for manufacturing a tire vulcanizing mold, the method comprising:
a cutting-out step of cutting out a mounting groove on a tire molding surface of a tire vulcanizing mold; and
a mounting step of mounting a stencil plate on the mounting groove, the stencil plate having a recess for forming a protruding identification mark on an outer surface of a tire,
wherein, in the cutting-out step, the mounting groove is cut out so as to form a bottom-raised portion at a position not interfering with the recess of the stencil plate, the bottom-raised portion being obtained by raising a bottom surface height of a part of the mounting groove.

12. A method for manufacturing a tire, the method comprising a step of vulcanizing and molding a tire by using the tire vulcanizing mold according to claim 1.

13. A method for manufacturing a tire, the method comprising a step of vulcanizing and molding a tire by using the tire vulcanizing mold manufactured by the method for manufacturing a tire vulcanizing mold according to claim 10.

14. A method for manufacturing a tire, the method comprising a step of vulcanizing and molding a tire by using the tire vulcanizing mold manufactured by the method for manufacturing a tire vulcanizing mold according to claim 11.
